(19) United States
(12) Patent Application Publication
(10) Pub. No.: US 2006/0178074 A1
(43) Pub. Date: Aug. 10, 2006

(54) Flat panel display device and its method of manufacture

(76) Inventors: Hyun-Ki Park, Suwon-si (KR); Dong-Sik Zang, Suwon-si (KR); Ik-Chul Lim, Suwon-si (KR); Kwi-Seok Choi, Suwon-si (KR); Kyu-Nam Joo, Suwon-si (KR); Jun-Kyu Cha, Suwon-si (KR); Dong-Gun Moon, Suwon-si (KR); Myun-Gi Shim, Suwon-si (KR); Myung-Duk Lim, Suwon-si (KR)

Correspondence Address: Robert E. Bushnell;Suite 300, 1522 K Street, N.W., Washington, DC, 20005, US

(21) Appl. No.: 11/327,314

(22) Filed: Jan. 9, 2006

(30) Foreign Application Priority Data
Feb. 5, 2005 (KR) 10-2005-0010964

(51) Int. Cl. H01J 9/18

(52) U.S. Cl. 445/35; 313/582; 445/24; 445/29

(57) ABSTRACT

A flat panel display device includes: a substrate; an electrode composed of metal; and an adhesive layer interposed between the substrate and the electrode. The electrode of the flat panel display device has excellent conductivity. The method of manufacturing the flat panel display device includes: preparing a metal substrate; forming a metal plating substrate by forming a plating mask layer on the metal substrate; forming an electrode on the metal plating substrate; separating the electrode, which is formed on the metal plating substrate, from the metal plating substrate with a cohesive layer; placing the separated electrode on another substrate using an adhesive composition; separating the cohesive layer from the electrode; and heat treating the adhesive composition to form an adhesive layer, the adhesive layer attaching the electrode to the another substrate. This method reduces the likelihood of malfunctioning electrodes being produced and leads to reduced manufacturing costs and processing time.

### CLAIM OF PRIORITY

This application makes reference to, incorporates the same herein, and claims all benefits accruing under 35 U.S.C. § 119 from an application for A FLAT DISPLAY DEVICE AND A METHOD FOR PREPARING THE SAME earlier filed in the Korean Intellectual Property Office on 5 Feb. 2005 and there duly assigned Serial No. 10-2005-0010964.

### BACKGROUND OF THE INVENTION

1. Field of the Invention

The present invention relates to a flat panel display and its method of manufacture, and more particularly, to a flat panel display device that includes a highly conductive electrode and an adhesive layer attaching the electrode to a substrate, and an inexpensive and simplified method of manufacturing the flat panel display device which can prevent the production of malfunctioning electrodes.

2. Description of the Related Art

Conventional display devices are used in monitors of personal computers, television sets, and the like. Display devices are categorized into Cathode Ray Tubes (CRTs) which utilize the emission of high-speed thermal electrons, Liquid Crystal Displays (LCDs) for which technology is developing at a fast rate, and flat panel display devices, such as Plasma Display Panels (PDPs) and Field Emission Displays (FEDs).

In PDPs, when a voltage is provided between transparent electrodes, a discharge occurs at the surfaces of a dielectric layer and a protective layer on an electrode, thus generating UV light. The UV light excites a phosphor coating on a rear substrate to emit visible light.

In FEDs, when a strong electric field is applied to emitters arranged at predetermined intervals on a cathode electrode, electrons are emitted from the emitters. The emitted electrons collide with a phosphor layer formed on an anode electrode, thus emitting light.

In PDPs, an electrode is formed by patterning an electrode material by screen printing. However, conventional screen printing processes are not suitable for a high resolution large-screen pattern that is required for PDPs because the screen printing processes require sophisticated skills and exhibit low precision. In addition, in conventional screen printing, short-circuits or disconnections can occur due to a screen defect, and the resulting resolution is limited. Accordingly, screen printing is not suitable for forming micro-pattern electrodes.

Recently, photolithography using a photosensitive paste has been developed to manufacture a high resolution electrode that is suitable for a large area. In a method of forming the high resolution electrode using photolithography, the photo sensitive paste is printed on the entire surface of, for example, a glass substrate, dried using a predetermined drying process, exposed using an UV exposing device having a photomask, and then developed using a predetermined developing agent to remove non-exposed portions that are not cured. The remained cured portions are heat-treated at a predetermined temperature, thus forming a patterned electrode. The method of forming an electrode using the photosensitive paste is disclosed in U.S. Pat. No. 5,037,723, for example.

However, the method of forming an electrode using the photosensitive paste requires an excessive amount of paste because of the loss of paste in exposing and developing operations. As a result, the manufacturing costs increase and the productivity decreases. In addition, the electrode resulting from the method consists of, in addition to metal, heat-treatment products of various organic and inorganic materials included in the paste. Accordingly, the conductivity of such an electrode is lower than that of an electrode that is formed of metal only. These problems must be solved.

### SUMMARY OF THE INVENTION

The present invention provides a flat panel display device including an electrode and an adhesive layer fixing the electrode to a substrate, and a method of manufacturing the flat panel display device.

According to one aspect of the present invention, a flat panel display device is provided including: a substrate; an electrode composed of metal; and an adhesive layer interposed between the substrate and the electrode.

According to another aspect of the present invention, a method of manufacturing a flat panel display device is provided, the method including: preparing a metal substrate; forming a metal plating substrate by forming a plating mask layer on the metal substrate; forming an electrode on the metal plating substrate; separating the electrode, which is formed on the metal plating substrate, from the metal plating substrate using a cohesive layer; placing the separated electrode on a substrate using an adhesive composition; separating the cohesive layer from the electrode; and heat-treating the adhesive composition to form an adhesive layer, thus attaching the electrode to the substrate.

The flat panel display device according to the present invention includes an electrode composed of metal and an adhesive layer fixing the electrode to a substrate. The electrode of the flat panel display device has excellent conductivity. In addition, electrodes composed of various metals can be manufactured at low costs in a short processing time using the method of manufacturing the flat panel display device. Furthermore, production of malfunctioning electrodes, which can be produced in operations of exposing and developing using an electrode forming paste, can be prevented because pre-manufactured electrodes are used.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a sectional view of electrodes of a flat panel display device according to an embodiment of the present invention;

FIG. 2 is an exploded perspective view of a Plasma Display Panel (PDP) of a flat panel display device according to an embodiment of the present invention; and

FIGS. 3 through 8 are views of a method of manufacturing a flat panel display device according to an embodiment of the present invention.

### DETAILED DESCRIPTION OF THE INVENTION

The present invention is described more fully below with reference to the accompanying drawings.

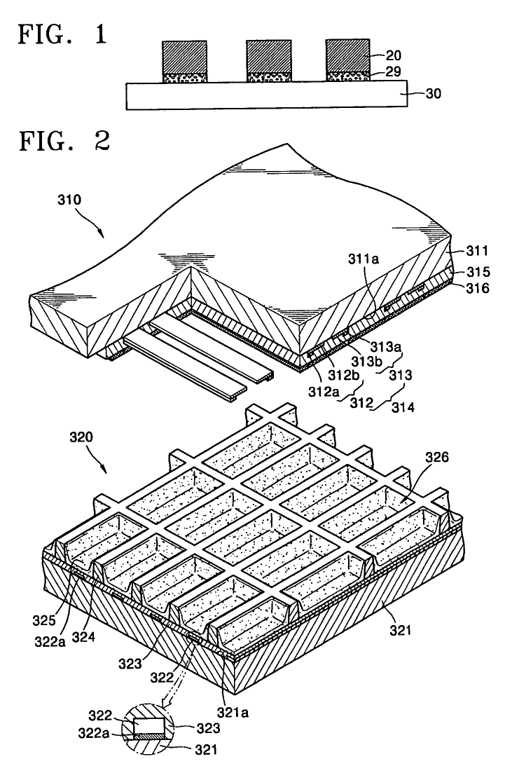

A flat panel display device includes a substrate; an electrode composed of a metal; and an adhesive layer interposed between the substrate and the electrode composed of the metal (refer to FIG. 1 illustrating a portion of the flat panel display device).

Referring to FIG. 1, an adhesive layer 29 is formed on a substrate 30, and an electrode 20 is formed on the adhesive layer 29. The term ‘substrate’ indicates a backing layer having a portion on which an electrode is to be formed. For example, when the electrode 20 is an address electrode of a plasma display panel, the substrate 30 can be a rear substrate. The substrate 30 can vary according to the kind of flat panel display device, and is easily known to those skilled in the art.

The electrode 20 is a conductive metal material, and can be formed of one of a group of metals consisting of Ag, Au, Cu, Ni, Pt, Pa, Al, or a combination of at least two of these metals. The electrode 20 can have a single layer structure composed of the metal, or can have an at least two layer structure composed of at least two different metals.

The adhesive layer 29 attaches the electrode 20 to the substrate 30. The adhesive layer 29 can be composed of a product obtained by heat treating an inorganic binder.

The inorganic binder can include at least one compound selected from the group consisting of PbO—SiO₂, PbO—B₂O₃—SiO₂, ZnO—SiO₂, ZnO—B₂O₃—SiO₂, Bi₂O₃—SiO₂, and Bi₂O₃—B₂O₃—SiO₂. However, the present invention is not limited thereto. The external shape of the inorganic binder can be spherical. However, the present invention is not limited thereto. An average diameter of the inorganic binder can be 5.0 μm or less. When the average diameter of the inorganic binder is greater than 5.0 μm, the surface of the heat-treated layer, that is, the surface of the adhesive layer 29 is non-uniform and the adhesive force between the electrode 20 and the substrate 30 is reduced.

In addition, the softening temperature of the inorganic binder can be in the range of 400° C. to 600° C., preferably, 350° C. to 450° C. When the softening temperature is less than 400° C., a vehicle can be ineffectively decomposed during the heat treatment. When the softening temperature is higher than 600° C., the substrate can be deformed during the heat treatment.

The thickness of the adhesive layer 29 can be in the range of 0.2 μm to 4 μm, preferably, 0.2 μm to 1 μm. When the thickness of the adhesive layer is less than 0.2 μm, the adhesive layer 29 fails to sufficiently attach the electrode 20 to the substrate 30. When the thickness of the adhesive layer is greater than 4 μm, the electrode 20 and the adhesive layer 29 can become excessively thick and the electrode 20 can have a rougher surface.

The electrode and the adhesive layer can be used in various flat panel display devices. For example, when a plasma display panel of a flat panel display device includes the electrode, the electrode can be an address electrode of a rear substrate or a bus electrode of a front substrate. However, the use of the electrode is not limited thereto.

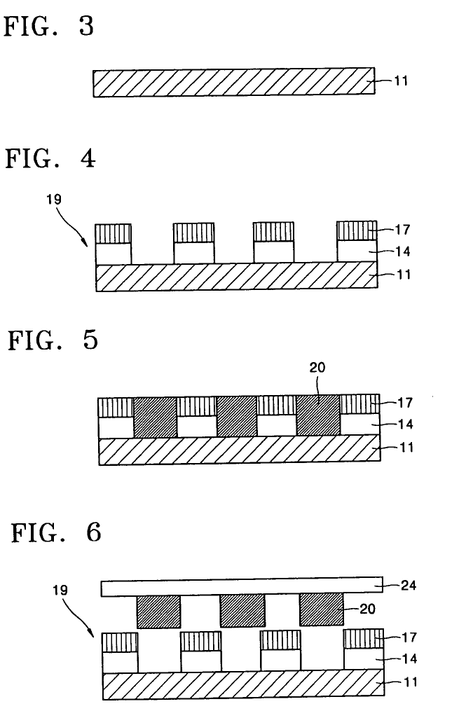

Various flat panel display devices including plasma display panels can be used in the present invention. FIG. 2 is an exploded perspective view of a plasma display panel of a flat panel display device according to an embodiment of the present invention.

The plasma display panel according to the current embodiment of the present invention can include a transparent front substrate; a rear substrate disposed parallel to the front substrate; barrier ribs which partition emission cells and are interposed between the front substrate and the rear substrate; address electrodes which extend along the emission cells arranged in a first direction and are covered by a rear dielectric layer; a pair of sustain electrodes that extend in a second direction crossing the first direction in which the address electrodes extend, and are covered by a front dielectric layer; red, green, blue phosphor layers coated on inner surfaces of barrier ribs; and a discharge gas contained within each emission cell.

Referring to FIG. 2, a front panel 310 includes a front substrate 311, a pair of sustain electrodes 314 including a Y electrode 312 and an X electrode 313 formed on a rear surface 311a of the front substrate 311, a front dielectric layer 315 covering the pair of sustain 18 electrodes 314, and a MgO protective layer 316 covering the front dielectric layer 315. The Y electrode 312 and the X electrode 313 respectively include transparent electrodes 312b and 313b composed of, for example, ITO and bus electrodes 312a and 313a composed of highly conductive metal.

A rear panel 320 includes a rear substrate 321, address electrodes 322 which are disposed perpendicular to the pair of sustain electrodes 314 on a rear surface 321a of the rear substrate 321, a rear dielectric layer 323 covering the address electrodes 322, a plurality of barrier ribs 324 that partition emission cells 326 and are formed on the rear dielectric layer 323, and phosphor layer 325 that is disposed in the emission cells 326. The address electrodes 322 are pre-manufactured and then attached to the rear substrate 321 by adhesive layers 322a formed by heat treating the adhesive composition. That is, the adhesive layer 322a and the address electrodes 322 are sequentially formed on the rear substrate 321 of the PDP. The address electrodes 322 and the adhesive layers 322a are already described.

Although FIG. 2 illustrates the address electrodes 322 of the PDP rear panel fixed to the substrate by the adhesive layer 322a, other electrodes, such as the bus electrodes 313a and 312a, can be formed according to the present invention.

A method of manufacturing a flat panel display device according to an embodiment of the present invention includes: preparing a metal substrate; forming a metal plating substrate; forming an electrode on the metal plating substrate; separating the electrode with a cohesive layer; placing the separated electrode on a substrate; separating the cohesive layer; and attaching the electrode by sintering.

The method of manufacturing a flat panel display device according to an embodiment of the present invention is described below.

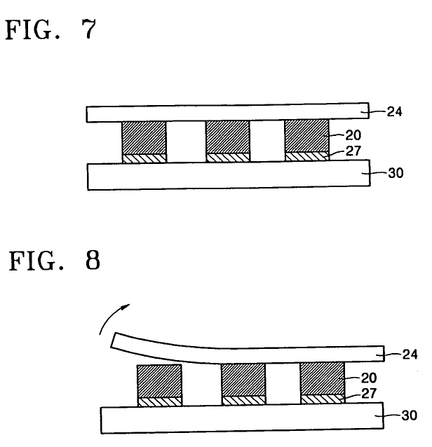

As illustrated in FIG. 3, a metal substrate 11 is prepared. The metal substrate 11 can have a surface roughness of 1 μm to 10 μm. When the surface roughness of the metal substrate 11 is outside this range, the electrode can be detached from the metal plating substrate in the subsequent metal plating process.

The metal substrate 11 can be composed of, for example, a material that can be electroplated. The metal substrate 11 can be composed of stainless steel (SUS), Ti, Ni, W, or an alloy of at least two of these metals. However, the present invention is not limited thereto.

Referring to FIG. 4, a plating mask layer 17 with a pattern corresponding to the shape of the to-be-formed electrode is formed on the metal substrate 11, thus forming a metal plating substrate 19.

The plating mask layer 17 on the metal substrate 11 can be composed of an insulating material because it is used as a plating mask in the subsequent plating process. The plating mask layer 17 can be, but is not limited to, a boro-phospho-silicate glass (BPSG) layer, a spin-on glass (SOG) layer, a phospho-silicate glass (PSG) layer, a diamond like carbon (DLC) layer, a SiOx layer, a SiNx layer, a SiONx layer, a TiOx layer, an AlOx layer, a Cr layer, a CrOx layer, a photoresist layer, or a combination of at least two of these layers.

The plating mask layer 17 can be formed using a method, such as, spin coating, sputtering, chemical vapor deposition, physical deposition, atomic deposition, or photolithography.

In FIG. 4, the plating mask layer 17 of the metal plating substrate 19 can include a CrOx layer 17b and a photoresist layer 17a.

The plating mask layer 17 can be formed by first coating CrOx on the entire surface of the substrate 11, and then coating a photoresist material on the CrOx layer to form a photoresist layer. Since the photoresist material composed of an organic material is coated on the CrOx layer, and not directly coated on the substrate 11, the separation of the photoresist material and the formation of undesired patterns can be prevented during the photolithography.

Although the plating mask layer 17 according to the present embodiment includes the CrOx layer 17b and the photoresist layer 17a, the plating mass layer 17 can be formed using other materials. In addition, the method of forming the plating mask layer 17 is not limited to the present embodiment.

Referring to FIG. 5, an electrode 20 is formed on the metal plating substrate 19.

The electrode 20 can be formed by plating, for example, electroplating. Electroplating is a plating method that uses an electric field. In electroplating, when an electric field is applied to the metal plating substrate 19 which is immersed in a plating solution, a metal salt contained in a plating composition is deposited on the metal plating substrate. That is, the metal plating substrate is plated.

In detail, according to a method of forming an electrode by electroplating, a cathode of a power source is connected to the metal substrate 11 of the metal plating substrate 19 through a first line, and an anode of the power source is connected to a source electrode through a second line. The source electrode and the electrode to be formed on the metal plating substrate 19 can be composed of identical materials. Then, the metal plating substrate 19 is immersed in a plating composition including a salt of a metal that forms the electrode to be formed on the metal plating substrate 19, and a predetermined current is applied from the power source for a predetermined time. As a result, the metal is deposited in an electrode forming area defined by the plating mask layer 17 of the metal plating substrate 19, thus forming an electrode 20.

In the electroplating, the plating composition can be an Ag plating composition, an Au plating composition, a Cu plating composition, a Ni plating composition, a Pt plating composition, a Pa plating composition, or an Al plating composition. In addition, at least two of these compositions can be sequentially used for the electroplating such that the electrode 20 illustrated in FIG. 5 can have at least a two-layered structure composed of at least two different metals.

Accordingly, the electrode 20 can be composed of Ag, Au, Cu, Ni, Pt, Pa, Al, or a combination of at least two of these metals. That is, the electrode 20 can be a single layer arrangement obtained using one composition selected from the Ag plating composition, the Au plating composition, the Cu plating composition, the Ni plating composition, the Pt plating composition, the Pa plating composition, and the Al plating composition. Alternatively, the electrode can be a multilayer arrangement formed by sequentially electroplating at least two different plating compositions selected from the Ag plating composition, the Au plating composition, the Cu plating composition, the Ni plating composition, the Pt plating composition, the Pa plating composition, and the Al plating composition. For example, when the Ag plating composition is selected, the electrode 20 shown in FIG. 5 can be composed of Ag only; when the Cu plating composition and the Ag composition are sequentially selected, the electrode 20 illustrated in FIG. 5 can be composed of two layers (Cu/Ag); and when the Cu plating composition, the Ag plating composition, and the Ni plating composition are sequentially selected, the electrode 20 illustrated in FIG. 5 can be composed of three layers (Cu/Ag/Ni.)

Then, the electrode 20 can be separated from the metal plating substrate 19 using a cohesive layer 24, as illustrated in FIG. 6.

The cohesive layer 24 can be attached to the electrode 20 formed on the metal plating substrate 19, and then lifted to separate the electrode 20 from the metal plating substrate 19. When lifting the electrode 20, an angle formed between the electrode 20 and the metal substrate 11 is constantly maintained such that the shape of the electrode 20, for example, a straight-line profile is not deformed. For example, the angle can be 45 degrees or less. The separation of the electrode 20 from the metal plating substrate 19 can be performed using, for example, a mechanical method using a roller, which has the cohesive layer 24.

The cohesive layer 24 can be composed of any material that can be attached to the electrode 20 such that the electrode 20 can be separated from the metal plating substrate 19. For example, the cohesive layer 24 can be composed of a vinyl resin, an acryl resin, a cellulose 1s resin, an epoxy resin, a silicon rubber, or the like. In detail, the cohesive layer 24 can be composed of polyvinyl alcohol resin, (meth)acrylic acid resin, methylmethacrylate resin, ethylmethacrylate resin, isobutylmethacrylate resin, normalbutylmethacrylate resin, normalbutylmethylmethacrylate resin, hydroxyethylmethacrylate resin, hydroxypropylmethacrylate resin, hydroxyethylacrylate resin, acrylamide resin, methylacrylate resin, glycidylmethacrylate resin, ethylacrylate resin, isobutylacrylate resin, normalbutylacrylate resin, 2-ethylhexylacrylate resin, ethyl cellulose resin, nitro cellulose resin, bisphenol A type epoxy resin, bisphenol F type epoxy resin, bisphenol S type epoxy resin, phenol novolak type epoxy resin, cresol block type epoxy resin, dimer acid modified epoxy resin, rubber modified epoxy resin, uretane modified epoxy resin, phenoxy resin, polyol modified epoxy resin, a copolymer resin or a terpolymer resin of at least two monomers of these, or the like. However, the material that forms the cohesive layer 24 is not limited thereto.

Referring to FIG. 7, the electrode 20 separated from the metal plating substrate 19 as illustrated in FIG. 6 is placed on the substrate 30 using the adhesive composition 27. The term ‘substrate’ indicates a backing layer having an area for the electrode, and varies according to devices to be formed. However, the ‘substrate’ can be easily known to those skilled in the art. For example, when the electrode 20 corresponds to an address electrode of a PDP, the substrate 30 can be a rear substrate of a rear panel of the PDP.

The adhesive composition 27 can include an inorganic binder and a vehicle.

The inorganic binder of the adhesive composition 27 is fused or softened in the subsequent heat treatment process to form the adhesive layer 29, thus providing an adhesive force between the electrode 20 and the substrate 30 (refer to FIG. 1.). The inorganic binder is described above.

The vehicle of the adhesive composition 27 can be selected to increase an adhesive force between the adhesive composition 27 and the electrode 20 such that the adhesive force between the adhesive composition 27 and the electrode 20 is stronger than the adhesive force between the cohesive layer 24 and the electrode 20. Therefore, when the electrode 20 is separated from the cohesive layer 24, the separation of the electrode 20 from the substrate 30 can be prevented.

In addition, during heat treatment, most of the vehicle is vaporized. Accordingly, the vehicle can be a material that can be thermally decomposed for removal at about 500° C. or lower, in consideration of the softening temperature of the inorganic binder. In detail, the vehicle is a material that can be decomposed at a relatively low temperature of 350° C. or lower in order to prevent formation of bubble traces to form a plan layer.

Any vehicle that has these properties can be used as the vehicle in the present invention. The vehicle in the adhesive composition 27 can be, but is not limited to, an acryl resin that can be easily obtained. The acryl resin can be polymethyl acrylate, polyethyl acrylate, polypropyl acrylate, polyisopropyl acrylate, polybutyl acrylate, poly(ethylene-co-ethylacrylate), poly(ethylene-co-acylic acid), polymethylmethacrylate (PMMA), polyethylmethacrylate, polybutylmethacrylate, polyacrylamide, or the like, but is not limited thereto.

The amount of the inorganic binder can be in the range of 0.1 to 5 parts by weight, preferably, 0.1 to 1 part by weight, based on 100 parts by weight of the adhesive composition. The amount of the vehicle can be in the range of 95 to 99.9 parts by weight, preferably, 99 to 99.9 parts by weight, based on 100 parts by weight of the adhesive composition. When the amount of the inorganic binder is less than 0.1 parts by weight based on 100 parts by weight of the adhesive composition, the adhesive force between the electrode 20 and the substrate 30 can be insufficient. When the amount of the inorganic binder is greater than 5 parts by weight based on 100 parts by weight of the adhesive composition, the residue can be increased after the heat treatment.

The adhesive composition 27 can be coated on the electrode 20 or the substrate 30 to a thickness of 1 μm to 40 μm, preferably, 5 μm to 10 μm. When the thickness of the adhesive composition 27 is less than 1 μm, the adhesive force between the electrode 20 and the substrate 30 can be insufficient. When the thickness of the adhesive composition 27 is greater than 40 μm, the drying time and heat treating time increase, leading to reduced productivity. In addition, the adhesive composition 27 can be dried such that the thickness of the adhesive composition 27 is in the range of 2 μm to 20 μm, preferably, 2 μm to 3 μm.

Referring to FIG. 8, the cohesive layer 24 is separated from the electrode 20. Since the adhesive force between the cohesive layer 24 and the electrode 20 is less than the adhesive force between the electrode 20 and the adhesive composition 27, the electrode 20 is not separated from the substrate 30 and the electrode 20 can be easily separated from the adhesive layer 24.

Then, the electrode 20 is attached to the substrate 30 by heat treatment. As illustrated in FIG. 1, the adhesive layer 29 formed by heat treatment of the adhesive composition 27 interposed between the electrode 20 and the substrate 30 provides the adhesive force between the electrode 20 and the substrate 30. The heat treatment can be performed at 400° C. to 650° C., preferably, 450° C. to 550° C. When the heat treatment temperature is lower than 400° C., the inorganic binder is insufficiently sintered and the thermal decomposition of the vehicle is inefficient so that the adhesive layer 29 formed by heat treatment the adhesive composition 27 is insufficiently formed and thus the electrode 20 fails to be attached to the substrate 30. When the heat treatment temperature is higher than 650° C., the substrate 30 can be deformed.

In order to effectively decompose the vehicle of the adhesive composition 27, the heat treatment can be performed at an oxygen-including ambient atmosphere or at an oxygen atmosphere. When the electrode 20 is composed of a material that can be oxidized at the oxygen atmosphere, such as Cu or the like, the electrode 20 can be coated with Cr, Ni, or the like to prevent oxidation, and then heat treated at an ambient atmosphere or the oxygen atmosphere.

Although the method of manufacturing a flat panel display device according to an embodiment of the present invention is described with reference to FIGS. 3 through 8, other embodiments can be used in the present invention.

The present invention is described below in further detail with reference to the 11 following example. This example is for illustrative purposes only and is not intended to limit the scope of the present invention.

### EXAMPLE

Manufacture of Plasma Display Panel

A 0.5 μm-thick CrOx layer was formed on a Ti substrate having a surface roughness of 10 μm. SU-8 (USA, obtained from Microchem Inc.) that is a negative photoresist was coated onto the CrOx layer using a spin coater, and then dried at 90° C. for 15 minutes to form a photoresist layer on the CrOx layer. A photomask corresponding to the pattern of an address electrode was placed on the photoresist layer. Then, the result was exposed to UV light of 365 nm for 160 seconds, developed using a developing solution for the SU-8, and then dried at 90° C. for 15 minutes. Then, the exposed CrOx was etched according to the electrode pattern using an etching solution for the CrOx, thus forming a patterned metal plating Ti substrate including a plating mask layer composed of the CrOx layer and the photoresist layer. The metal plating Ti substrate was connected to a cathode of a Ti plate (obtained from Advanced Material Inc.) that is a power source, and an anode of the power source was connected to an Ag electrode. Then, the metal plating Ti substrate was immersed in an AgCN-based alkali plating solution (obtained from Juamdoyun Plating Chemicals Inc.) that is an Ag plating composition, and then Ag plating was performed at a current density of 2.5 A/dm2 at 25° C., thus forming an Ag electrode with a thickness of 3.5 μm on the metal plating Ti substrate. The metal plating Ti substrate on which the Ag electrode was formed was washed with pure water, an acryl resin, (obtained from Geomyung Co., Ltd.) that is, a cohesive layer was placed on the Ag electrode, and then the Ag electrode was separated from the metal plating Ti substrate when an angle between the Ag electrode and the Ti substrate was 45 degrees. Separately, an adhesive composition containing PbO—SiO₂ frit as an inorganic binder and an acryl resin (obtained from Geomyung Co., Ltd.) as a vehicle was prepared. In the adhesive composition, the amount of the PbO—SiO₂ frit was 5 parts by weight and the amount of the acryl resin as the vehicle was 95 parts by weight. Then, the adhesive composition was coated on portions of the separated Ag electrode that did not contact the cohesive layer to a thickness of 40 μm, and then dried at 120 degrees C. for 10 minutes. Then, the result was placed on a rear substrate that is a lower substrate of a PDP, and then heat-treated in an oxygen atmosphere at 600° C. to form a 1 μm-thick adhesive layer, thus fixing the Ag electrode to the rear substrate of the PDP. Subsequently, a rear dielectric layer, an emission cell, and a phosphor layer in the emission cell were sequentially formed to produce the rear panel of the PDP. The rear panel was coupled to a front panel that includes a front substrate, a pair of sustain electrodes, a front dielectric layer covering the sustain electrodes, and a MgO protective layer. Then, the coupled rear and front panels were evacuated and then injected with a discharge gas, to manufacture a PDP.

A flat panel display device according to the present invention includes an electrode composed of metal and an adhesive layer fixing the electrode to a substrate. The electrode of the flat panel display device according to the present invention is different from an electrode formed using an electrode forming paste composition in that the electrode is formed of metal only without the result obtained by heat treatment of organic and inorganic materials contained in the paste composition. Accordingly, the electrode of the flat panel display device according to the present invention has excellent conductivity.

The use of a method of manufacturing a flat panel display device according to the present invention can reduce the manufacturing costs by at least 50% ofthe manufacturing costs required when an Ag electrode is formed by exposing and developing using an Ag paste composition. In addition, when a Cu electrode is formed using the method according to the present invention, the manufacturing costs can be reduced by 90% or greater. That is, the use of a pre-manufactured electrode reduces the manufacturing costs and processing time. In addition, since a well-functioning electrode can be selected from pre-manufactured electrodes, the electrode of the flat panel display device has a straight-line profile and a precise pattern, and the production of malfunctioning electrodes can be prevented. Accordingly, a flat panel display device manufactured using the method of the present invention is highly reliable.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A flat panel display device, comprising:
a substrate;
an electrode composed of metal; and
an adhesive layer interposed between the substrate and the electrode.

2. The flat panel display device of claim 1, wherein the metal comprises either a metal selected from the group consisting of Ag, Au, Cu, Ni, Pt, Pa, Al, or a combination of at least two metals selected from the group.

3. The flat panel display device of claim 1, wherein the electrode comprises at least a two-layered structure composed of different metals.

4. The flat panel display device of claim 1, wherein the adhesive layer comprises a heat treated inorganic binder.

5. The flat panel display device of claim 4, wherein the inorganic binder comprises at least one binder selected from the group consisting of PbO—SiO₂, PbO—B₂O₃—SiO₂, ZnO—SiO₂, ZnO—B₂O₃—SiO₂, Bi₂O₃—SiO₂, and Bi₂O₃—B₂O₃—SiO₂.

6. The flat panel display device of claim 1, wherein the adhesive layer has a thickness in a range of 0.2 μm to 4 μm.

7. The flat panel display device of claim 1, wherein the electrode comprises an address electrode of a plasma display device.

8. The flat panel display device of claim 1, wherein the electrode comprises a bus electrode of a plasma display device.

9. A method of manufacturing a flat panel display device, the method comprising:
preparing a metal substrate;
forming a metal plating substrate by forming a plating mask layer on the metal substrate;
forming an electrode on the metal plating substrate;
separating the electrode, which is formed on the metal plating substrate, from the metal plating substrate with a cohesive layer;
placing the separated electrode on another substrate using an adhesive composition;
separating the cohesive layer from the electrode; and
heat treating the adhesive composition to form an adhesive layer, the adhesive layer attaching the electrode to the another substrate.

10. The method of claim 9, wherein the plating mask layer on the metal plating substrate comprises either one of a boro-phospho-silicate glass (BPSG) layer, a spin-on glass (SOG) layer, a phospho-silicate glass (PSG) layer, a diamond like carbon (DLC) layer, a SiOx layer, a SiNx layer, a SiONx layer, a TiOx layer, an AlOx layer, a Cr layer, a CrOx layer, a photoresist layer, or a combination of at least two of these layers.

11. The method of claim 9, wherein the electrode is formed by electroplating.

12. The method of claim 9, wherein the electrode is formed of either at least one metal selected from the group consisting of Ag, Au, Cu, Ni, Pt, Pa, Al, or a combination of at least two metals selected from the group.

13. The method of claim 9, wherein the adhesive composition comprises an inorganic binder and a vehicle.

14. The method of claim 13, wherein the inorganic binder comprises at least one compound selected from the group consisting of PbO—SiO₂, PbO—B₂O₃—SiO₂, ZnO—SiO₂, ZnO—B₂O₃—SiO₂, Bi₂O₃—SiO₂, and Bi₂O₃—B₂O₃—SiO₂.

15. The method of claim 13, wherein the vehicle comprises an acryl resin.
